(19) United States
(12) Patent Application Publication
(10) Pub. No.: US 2001/0036199 A1
(43) Pub. Date: Nov. 1, 2001

(54) Architecture and method for automatic distributed gain control for modem communications over passive multipoint networks

(76) Inventor: John B. Terry, Cumming, GA (US)

Correspondence Address: Daniels & Daniels, P.A., Post Office Drawer 12218, Research Triangle Park, NC, 27709-2218, US

(21) Appl. No.: 09/818,378

(22) Filed: Mar. 27, 2001

Related U.S. Application Data
(60) Provisional application No. 60/193,855, filed on Mar. 30, 2000.

(51) Int. Cl. H04H 1/04

(52) U.S. Cl. 370/487; 370/282

(57) ABSTRACT

A system and method of compensating for path losses for data transmissions from various remote modems to a central modem for use in a system that provides data communications over a passive multipoint network such as coaxial tree and branch cable television distribution network. The central modem communicates to remote modems. The remote modems can be placed in communication with a downstream device (such as a personal computer) to allow the downstream device to communicate with the central modem and ultimately with a wide area network such as the Internet.

The present application claims priority from U.S. Provisional Application Serial No. 60/193,855 filed on Mar. 30, 2000.

This application builds upon concepts disclosed in co-pending application with common assignee with from U.S. patent application Ser. No. 09/482,836 for High Speed Data Communications Over Local Coaxial Cable with the priority date of Jan. 13, 1999. To reduce repetition with the material disclosed in the '836 application, the '836 application is incorporated by reference.

For the convenience of the reader, various acronyms and other terms used in the field of this invention are defined at the end of the specification in a glossary. Other terms used by the applicant to define the operation of the inventive system are defined throughout the specification. For the convenience of the reader, applicant has added a number of topic headings to make the internal organization of this specification apparent and to facilitate location of certain discussions. These topic headings are merely convenient aids and not limitations on the text found within that particular topic.

In order to promote clarity in the description, common terminology for components is used. The use of a specific term for a component suitable for carrying out some purpose within the disclosed invention should be construed as including all technical equivalents which operate to achieve the same purpose, whether or not the internal operation of the named component and the alternative component use the same principles. The use of such specificity to provide clarity should not be misconstrued as limiting the scope of the disclosure to the named component unless the limitation is made explicit in the description or the claims that follow.

### BACKGROUND

The demand for high-speed Internet access is driving the telecommunications industry like few forces have in the past. While the Cable and Telephone industry position their networks for the future, ever-changing technology has previously made it both costly and risky to invest in new delivery systems.

Most current approaches for delivery of Internet services in MDUs (“Multiple Dwelling Units”) utilize telephone wiring in “data above voice” configurations. Such approaches usually require selective identification and disconnection of each telephone pair and the insertion of a modem function at the central end of the telephone loop. Such intrusive installation is both costly and time consuming. A second modem is required at the user end of the telephone pair to connect to the user's PC (“Personal Computer”) or in-home network. Since MDU telephone wiring generally has a worse inter-pair crosstalk performance than that of outside wiring and suffers considerable electrical ingress interference it is usual to insert the data on the telephone loop within the building to ensure adequate performance.

The high frequency loss of longer telephone loops between the central office and the MDU considerably limits potential two-way transmission speed for longer telephone loops.

The use of low-cost wireless data transmission works well where the distances are short and spectrum is abundant. However, for densely populated MDUs, this is not usually the case.

### The Present Cable Environment

Cable Modem Internet service has now penetrated well over one million residences and has become extremely popular due to its exceptional speed. However, the introduction of Cable Modem service in MDUs is problematic due to the complex and irregular topology of the TV coax wiring and the sharing of limited available upstream bandwidth. In addition, points of ingress interference in MDU coax distribution and home wiring are very difficult to locate and particularly difficult to isolate. Such ingress interference can cause failure of two-way services to all users in an MDU and potentially other users upstream of the MDU on the Hybrid Fiber-Coax (HFC) network.

Both Cable Modem and Telephone loop data modems are usually interfaced to the PC using an Ethernet 10baseT connection. This requires that a Network Interface Card (NIC) be installed in each PC and the PC network software configured. Since the average PC users are not usually technically skilled, this installation and/or configuration is frequently performed by the Cable or Telephone network provider. In this way, the network provider becomes potentially liable for problems in the PC, often when the trouble is not related to the network provider's work. While this issue can be alleviated in some cases by use of USB (“Universal Serial Bus standard”) ports, a large proportion of PCs are not so equipped. In hotel/motel situations, users do not generally require networking between themselves and are rarely adept or willing to reconfigure their PCs each time they rent a room or return to their home or office.

Coax distribution systems such as those found in MDUs, hotels, hospitals, and university campus facilities, which can be served by Cable, Satellite or Broadcast network operators, are usually configured as passive “tree and branch” systems using splitters and/or relatively long coax runs with taps or couplers arranged to serve the apartments or rooms. Such passive distribution arrangements frequently serve from 30 to 100 rooms or apartments and are arranged such that the TV signal levels fed to each apartment or hotel room are typically within a 10 dB range. These coax distribution systems typically have losses in the range of 15 dB to 25 dB and are usually fed from a centralized one-way broadband TV channel amplifier to ensure adequate signal levels for the users. Larger high-rise MDUs and hotels usually have a number of centralized amplifiers each feeding a passive coax distribution sub-system serving separate areas or floors of the building.

### The Opportunity

The spectrum of the MDU TV services usually lies below 750 MHz, whereas the coax cable can handle frequencies beyond 1 GHz. The passive splitters or couplers (collectively “joiner devices”), although usually only rated for use in the TV bands, usually perform adequately in terms of loss and/or port isolation when carrying more robust digital signals of up to 1 GHz. Furthermore, the loss per unit length of the inbuilding coax wiring, rather than being a problem, helps attenuate echoes at these higher frequencies and thus permits much simpler equalization in digital receivers.

Clearly there is an opportunity to utilize the higher frequency spectrum of inbuilding coax for high-speed Internet access services using robust digital modulation techniques. Ingress interference is very much less at frequencies above those of TV channels and, being contained by the one-way characteristic of the central TV channel amplifiers—at least at the TV downstream channel frequencies and higher, any ingress interference is prevented from exiting the MDU and interfering with the HFC Cable network.

The available above-TV-channel spectrum in in-building coax can be arbitrarily divided up to offer high-speed data in both directions. Due to the relatively high field-strength radiation of portable cellular handsets, it is prudent to operate at frequencies of 900 MHz and above. Using presently installed splitters and couplers it is also better to keep to frequencies of 1 GHz and below. This available 100 MHz of available spectrum is plenty to serve the statistical two-way Internet access needs of 50 to 100 users or client modems. If higher capacity is needed, additional downstream spectra can be allocated in bands between 1 GHz and about 1.6 GHz provided that higher frequency specified splitters are substituted. Such higher uni-directional capacity can provide for additional digital video-on-demand (VOD) services, in either Internet Protocol (IP) format or in native MPEG2 format. In all cases the spectrum between 900 MHz and 930 MHz can be utilized for upstream transmission. The use of this single upstream spectrum provides adequate traffic capacity and simplifies control.

### BRIEF SUMMARY OF DISCLOSURE

An alternative system approach has been devised which takes advantage of the topology and performance of in-building coax distribution to provide high-speed Internet services.

This system architecture is DOCSIS-compliant at a network level, consistent with existing Cable Modem operation and service practices and yet offers plug and play end-user attachment without PC reconfiguration or installation of an Ethernet NIC card (NIC stands for “Network Interface Card”). At the same time the approach isolates within MDU ingress interference from the main hybrid fiber-coax network and provides bandwidth management and efficiency, particularly in the upstream or return direction.

The per-MDU common equipment installation is extremely simple and there is no need for a truck-roll or appointment to provide service to each customer. Indeed, the customer interface can be drop-shipped to the consumer and is easier to hook-up than a VCR. Multi-megabit Internet access is achieved through the use of the PC's existing parallel or USB port using a simple “enabler” which can be optionally loaded from the MDU central hub modem, via the PC's existing serial connector—no floppy disks or CDs.

The primary purpose of this “enabler” is to place a “connection” icon on the user's desktop for ease of access to the service. There is never the need to perform another enabler load when moving the PC between client modems, such as when moving between hotel rooms or returning home, as the “enabler” does not need to contain any addressing or configuration information.

The client modem of the present invention is extremely simple since it does not require a tuner or even a microprocessor for its operation. Other simplifications result in a complexity of around a quarter of that of a conventional Cable modem. The client modem is thus very low in cost and this cost will continue to track at significantly less than half of the cost of technology-evolving conventional cable modems. Additionally, the user interface of the present invention consumes less than one tenth of the power of that of a Cable Modem. Installation costs are minimal and marketing of the service by the Cable MSO is simplified as service may be offered on a same-day trial basis.

The client modem can be packaged on a single printed circuit board housed in a plastic case of approximately the size of a small cellular phone. This case may be included as a pod inserted in a piece of coax cord connected to a coax wall receptacle. This pod will also have a thin data cord with a multi-faceted connector that may be inserted into the parallel, serial or USB connector on a PC or laptop. An alternative embodiment of the client modem is equipped with an infrared transceiver for communication with similarly equipped PCs or PDAs (“Personal Digital Assistants”). Power is provided using a low-cost, single AC voltage, UL/CSA approved, transformer cube.

It is an object of the present invention to provide for a method of compensating for path losses for data transmissions from various remote modems to a central modem.

It is an object of the present invention to provide for a method of compensating for path losses for data transmissions from various remote modems to a central modem for use in a system that provides data communications over a passive multipoint network such as coaxial tree and branch cable television distribution network to remote modems which can be placed in communication with a downstream device to allow the downstream device to communicate with the central modem and ultimately with a wide area network such as the Internet.

These and other advantages of the present invention are apparent from the detailed description that follows.

### BRIEF DESCRIPTION OF THE DRAWINGS

FIG. 1 is a diagram illustrating the overall architecture of the present invention.

### DETAILED DESCRIPTION OF THE DISCLOSED EMBODIMENT

### Architecture

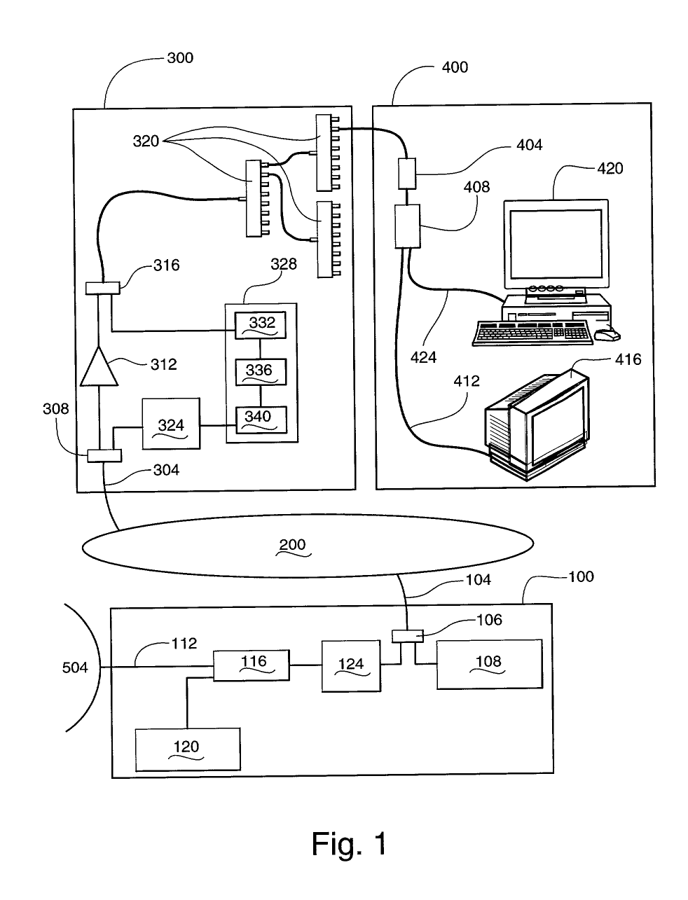

A diagram illustrating the overall architecture of the present invention is shown in FIG. 1. FIG. 1 can be subdivided into four clusters of components. The first cluster is Cable-TV Headend equipment 100. The second cluster is the Hybrid Fiber-coax (HFC) Distribution Network 200. The third cluster is the premises coax distribution equipment 300 which could exist in either an MDU or an analogous situation such as a hotel. The final cluster is the cluster of equipment in the user's room 400. Clusters 300 and 400 contain elements of the present invention. In keeping with industry conventions, the Cable-TV headend and the Internet are the upstream end of FIG. 1 for cable TV and IP data respectively. The television set or computer in the user's room are the downstream points. Upstream data transmissions travel upstream towards the upstream end. Downstream transmissions travel downstream towards the downstream end. Thus a component on a data path receives a downstream data transmission from its upstream end and a upstream data transmission from its downstream end.

The contents of the individual clusters are described below. In cluster 100, a cable TV signal is provided to the HFC distribution network 200 via connection 104. The source of the cable TV signal may be from conventional equipment represented by Cable-TV Service Elements 108 connected to one leg of joiner device 106. Digital communication signals from Internet 504 travel through Internet connector cable 112 to Router 116 which is in communication with Internet Service Management 120. The digital communication signals pass through the Cable Modem Termination System 124 and joiner device 106 when moving downstream from the Router 116 to the connection 104 to the HFC Distribution Network 200. The description of selected elements of the Cable-TV Headend is to provide context for the present invention and does not constitute a limitation or required elements for the present invention.

In cluster 300, the incoming signal from the HFC Distribution Network 200 is carried on cable 304 to joiner device 308. The joiner device 308 is connected to the input of TV Channel Amplifier 312. The Output of TV Channel Amplifier 312 is passed to a second joiner device 316 and then to set of one or more joiner devices forming the tree and branch distribution network 320 terminating at a series of TV coax Receptacles 404. The technology for tree and branch networks suitable to distribute Cable TV signals is well known to those of skill in the art. Thus, in order to avoid unnecessary clutter, the tree and branch network 320 is shown with just a few joiner devices and connecting cables rather than the full set of components for a tree and branch network.

Joiner devices 308 and 316 form a bypass around the TV Channel Amp 312. This bypass loop has a cable modem 324 at the upstream end and data hub 328 (“hub”) of the present invention at the downstream end of the bypass loop.

Within cluster 400, a client modem 408 connects to TV coax receptacle 404. A connector (not shown) allows a conventional TV coax cable 412 to run from the client modem 408 to a television 416. The user may connect a downstream device 420 to the data cord 424 of client modem 408 with the appropriate port connector for connection to the user's downstream device 420 such as a personal computer (“PC”) as shown in FIG. 1. While the downstream device 420 is likely to be either a desktop or laptop personal computer, it could be some other device capable of interfacing with an external source of digital data. One such example is the range of devices know as PDAs (“Personal Digital Assistants”). Thus, the present invention allows for communication between the PC 420 and the Internet 504 through substantial use of existing infrastructure used to deliver cable TV signals to user's television 416.

In this arrangement a single DOCSIS-compliant off-shelf Cable Modem 324 is used to serve the statistical data needs of multiple users connected via a passive in-building coax distribution system.

At the user or client ends of the system a very simple modem interface is used to interface to the user's computer 420 via its existing serial, parallel or USB port. In this way, no NIC card or network configuration is required in the users PC. Point-to-Point Protocol (PPP) is carried on RF channels on the in-building coax distribution 320 to a central RF modem 332 within the proxy server 328.

A protocol converter 336 is provided between this central RF modem 332 and the shared DOCSIS-compliant Cable Modem 324. This protocol converter 336 translates the data format between the Point-to-Point Protocol used by the PC and the 10baseT used by the DOCSIS Cable modem. Thus any IP protocol, such as TCP/IP, UDP/IP, etc., is carried transparently to and from the Internet 504. Special prioritization is available for low-latency requirement traffic, such as IP voice or multimedia, in both directions of transmission.

The protocol converter 336 also acts as a proxy server in order to connect the many client modems and their PCs to one or a few DOCSIS-compliant Cable modems (to avoid clutter, FIG. 1 shows a single cable modem). This involves providing IP addresses to the PCs in response to PPP connection requests. The protocol converter 336 translates single or multiple socket addresses that uniquely identify multiple sessions or windows running within each PC, in order to present unique socket addresses to servers that exist on the IP network. 504.

The field-trial version of the hub with protocol converter is supported by a PC motherboard and is packaged, together with the central modem RF board, in a PC rack-mount, pizza box sized case, for wall mounting. This PC motherboard, upon booting, makes a DHCP request via its Cable modem to a server in the headend and receives a leased IP address—just like a user-PC provided with regular Cable modem service. If the hub with protocol converter has multiple Cable modem connections to the headend then this action is repeated for each Cable modem.

The many client-PC's are be made to appear, from a headend service management perspective, as though they are connected via individual Cable modems. Thus a function is provided in the headend that collects associated user-PC MAC and assigned IP address information from the protocol converter and presents this as an interface to Internet Headend service management 120 that also manages single-user Cable Modem services.

### RF Transmission

The in-building RF system presently uses 15 Msymbol/sec Binary Phase Shift Keying (“BPSK”) or Quadrature Phase Shift Keying (“QPSK”) modulation in a single downstream “channel” with a center frequency of approximately 970 MHz. Higher symbol rates are planned which could offer at least 30 Mb/s net downstream data capacity.

The downstream signal is transmitted continuously and formatted in a standard MPEG2/DVB structure. The MPEG2 frames comprise a framing (47 hex)/super-framing (inverted 47 hex) byte, 187 information bytes and 16 forward error correcting (FEC) bytes—a total of 204 bytes. Certain reserved MPEG2 “Packet IDentification” (PID) codes are used to indicate that the following information bytes are data of a particular type rather than digital video or idle frames.

Conventional synchronized scrambling is employed for spectral reasons and the 16-byte FEC field is always used or reserved for error correction. These structures facilitate the use of the same industry-standard off-shelf set-top technologies in both data and digital TV applications. Frame interleaving, while available, is not used in inbuilding passive coax distribution as this would delay latency-sensitive traffic and is not necessary for error protection purposes.

Upstream transmission in the in-building coax uses a BPSK modulated 915 MHz RF signal carrying a 15 Mb/s digital stream. Upstream transmission is only permitted from one client modem at a time as specified by downstream “polling” contained in the downstream data control envelope. Thus, there is no collision of upstream signals. The upstream signal comprises a preamble signal that is ramped up in level followed by a sync byte. A scrambled client modem source address, a length field and then data follow this preamble. The length of the data field is dependent on how much is requested by the central modem or the remaining amount of upstream data buffered in the client modem. As in the downstream direction, special provision is made for the needs of low-latency traffic.

### Coax Path Loss Compensation

Path losses between each client modem 408 and the central RF modem 332 will have a wide variation due to the coax distribution topology and loading variations. The system is designed to accept losses of 40 dB or more.

Loss variations in the downstream direction are compensated by an automatic gain control (“AGC”) function contained in each client modem receiver.

The upstream AGC method involves adjusting each of the client modem transmitters such that their signals, upon arrival at the upstream receiver in the central modem, are approximately equal.

Each time a data burst is sent to a client modem 408 an extra bit is included which indicates if the previous transmitted burst from that client modem was above or below the ideal level required at the receiver within the central RF modem 332. This bit is used by the client modem 408 to slightly adjust, either upward or downward, the level of its next transmitted burst. Thus all signals received by the central RF modem 332 from every client modem become aligned in level and cycle upward and downward by a small amount. This is an ideal situation since the upstream BPSK receiver has a much wider acceptable input signal range than the small level variations received. Control systems of this type are fast to react to changes in transmission path attenuation and are intrinsically stable.

### Privacy

A minimal cost moderate level of data privacy is provided using individual spectral scrambling sequences and/or sequence start points for each client modem 408 in each direction. The method of establishing such scrambling sequences is itself secure. Higher levels of encryption security, like those used in DOCSIS-compliant Cable modems, will be made available, where required, at a slightly additional cost.

### Techologies

One embodiment of the present invention uses available low-cost, commercial RF and digital technologies. Alternative embodiments include a client modem receiver that uses tuner/demodulator chipsets commonly used in satellite set-top boxes.

One alternative embodiment calls for moving most functions into a pair of custom chips; one a small RF analog chip, the other a semi-custom chip containing the digital functions. This technology evolution will result in a client modem the size of a small cellular phone that may become part of a coax cord assembly and consume very little power.

The hub 328 is presently constructed using a normally rack-mounted diskless, low cost, PC motherboard equipped with an RF/protocol board 336 and one or more 10baseT NIC interfaces 340. This may be mounted, together with one or more off-shelf cable modems 324, on a wall adjacent to the existing building TV distribution amplifier 312.

### Installation

As illustrated in FIG. 1, the central installation requires only the addition of two coax joiner devices 308 and 312 to which are attached a conventional cable modem 324 and the hub 328. The client modems are simply introduced, by the end-user, between the TV coax receptacle 404 and TV set 416 (if any). An associated transformer cube (not show in FIG. 1) is then plugged into a convenient power receptacle and the data cord 424 plugged into the user's PC. No network-stack configuration of the PC is required, thus offering a real plug-and-play high-speed Internet access service.

### Summary

The system presents a new, economic approach for MDU or hotel high-speed Internet access that works well over existing in-building coax.

This system is DOCSIS-compliant as seen from the headend networking elements, consistent with existing Cable Modem operation and service practices and yet offers plug and play end-user attachment without PC reconfiguration or installation of an Ethernet NIC card in the user's PC. The per-MDU common equipment installation is extremely simple and there is no need for a truck-roll or appointment to provide service to each customer. Indeed, client modems can be mailed and are easier to hook-up than a VCR.

The approach isolates internal MDU ingress interference from the main HFC network and provides improved bandwidth management and efficiency, particularly in the upstream or return direction.

Multi-megabit Internet access is achieved via the PC's existing parallel or USB port using a simple “enabler” that places a connection icon on its desktop and activates the PC's existing PPP direct connection facility. The “enabler” can be loaded from the hub 328 via the PC's existing serial connector—no floppy disks or CDs.

The system in accordance with the present invention is, and will track at, significantly less than half of the cost of a conventional Cable modem approach. Additionally, the user interface in the client modem consumes less than one tenth of the power of that of a Cable Modem.

Marketing of the service by the Cable MSO is simplified as whole-MDU installation may be offered on a same-day trial basis.

Those skilled in the art will recognize that the methods and apparatus of the present invention has many applications and that the present invention is not limited to the specific examples given to promote understanding of the present invention. Moreover, the scope of the present invention covers the range of variations, modifications, and substitutes for the system components described herein, as would be known to those of skill in the art.

The legal limitations of the scope of the claimed invention are set forth in the claims that follow and extend to cover their legal equivalents. Those unfamiliar with the legal tests for equivalency should consult a person registered to practice before the patent authority which granted this patent such as the United States Patent and Trademark Office or its counterpart.

1. A method of compensating for path losses for data transmissions in the upstream direction for a tree and branch network having at least two remote modems, the method comprising:
a) establishing a target level for received signal strength of upstream data transmissions received by a central modem;
b) measuring the received signal strength of a first upstream data transmission from a first remote modem with the first unique identification value;
c) providing feedback to the first remote modem regarding the received signal strength of the first upstream data transmission to the central modem from the first remote modem;
d) responding to the feedback by adjusting the output level of the first remote modem to attempt to adjust the received signal strength of a second upstream data transmission from the first remote modem to the central modem towards the target level;
e) measuring the received signal strength of the second upstream data transmission from the first remote modem with the first unique identification value;
f) providing feedback to the first remote modem regarding the received signal strength of the second upstream data transmission to the central modem from the first remote modem; and
g) responding to the feedback by adjusting the output level of the first remote modem to attempt to adjust the received signal strength of a third upstream data transmission from the first remote modem to the central modem towards the target level.

2. The method of claim 1 wherein each step of providing feedback further includes:
a) comparing the measured signal strength with the target signal strength; and
b) sending data of a first type to the first remote modem if the signal strength of the previous data transmission to the central modem was above the target level and sending data of a second type to the first remote modem if the signal strength of the previous data transmission to the central modem was below the target level.

3. The method of 2 wherein each step of responding to the feedback comprises adjusting the output level of the first remote modem by a first amount in response to feedback indicating that the received signal strength needs to increase, and adjusting the output level of the first remote modem by a second amount in response to feedback indicating that the received signal strength needs to decrease.

4. The method of claim 1 wherein the feedback to the first remote modem is provided with a downstream data transmission addressed to the first remote modem.

5. A client modem for use in a passive multipoint distribution network wherein the client modem is adapted to:
a) transmit data upstream along the distribution network to an central modem;
b) receive data transmitted downstream from the central modem;
c) determine if the transmitted data is addressed to the client modem; and
d) respond to control data sent with the transmitted data addressed to the client modem to adjust the output level of the next transmission of data upstream to the central modem.

6. The method of claim 1 wherein the method further comprises:
h) measuring the received signal strength of the each subsequent upstream data transmission from the first remote modem with the first unique identification value;
i) providing feedback to the first remote modem regarding the received signal strength of the each subsequent upstream data transmission to the central modem from the first remote modem; and
j) responding to the feedback by adjusting the output level of the first remote modem to attempt to adjust the received signal strength of a next upstream data transmission from the first remote modem to the central modem towards the target level.

7. The client modem of claim 6 wherein the client modem is further adapted to compensate for loss variations in the downstream direction through use of an automatic gain control function contained within the client modem such that the client modem operates one loss compensation system for downstream transmissions and one loss compensation system for upstream transmissions.

8. The client modem of claim 6 wherein the client modem is:
a) adapted to be connected to a coax television receptacle on the upstream side of the client modem;
b) adapted to pass to a downstream coax cable a band of frequencies containing at least one cable television channels;
c) adapted to pass data from the central modem that is addressed to the client modem to a downstream data cable;
d) adapted to receive data from the downstream data cable; and
e) adapted to transmit upstream the received data from the downstream data cable in response to a polling signal from the central modem providing permission for that particular client modem to conduct an upstream transmission.

9. The client modem of claim 6 wherein the client modem includes an infrared transceiver for communication with a similarly equipped device.

10. The client modem of claim 6 wherein the client modem is:
a) adapted to pass data from the central modem that is addressed to the client modem to a downstream data cable wherein the downstream data cable has at least two downstream connectors that allow the downstream data cable to form a communication link with a first computer at a first time through one type of communication connection and with a second computer at a second time through a second type of communication connection;
b) adapted to receive data from the downstream data cable; and
c) adapted to transmit upstream the received data from the downstream data cable in response to a polling signal from the central modem providing permission for that particular client modem to conduct an upstream transmission.

11. The client modem of claim 9 wherein communication connection is selected from the group consisting of serial connection, parallel connection, and USB connection.

12. A communication hub with a data path for use at the upstream end of a tree and branch distribution network using an internal data communication protocol with at least two remote modems, the communication hub located between the tree and branch distribution network and at least one central modem in connection with an external network using an external data communications protocol using IP addresses, the external data communications protocol different from the internal data communications protocol, the hub comprising:
a) a connection port for connection to the tree and branch distribution network to allow the hub data path to receive data transmissions from at least two remote modems;
b) a connection port for connection to at least one central modem connected to the external network;
c) a measurement circuit to measure the signal strength of a data transmission from a remote modem;
d) a means to receive downstream data transmissions from at least one central modem directed to one of the at least two remote modems;
e) a means to transmit downstream data transmissions with addressing information that allows the particular modem to identify the downstream data transmission as uniquely addressed to the particular modem;
f) a protocol converter adapted to route communications between the at least two remote modems and a smaller number of at least one central modem; and
g) a means to provide signal strength feedback to the particular remote modem to allow the remote modem to adjust the signal strength sent by the particular modem.

13. The communications hub of claim 12 wherein the hub further comprises:
An RF Modem at the downstream portion of the hub data path; and
A Network Interface unit at the upstream portion of the hub data path;
And wherein the protocol converter
a) connects the RF Modem and the Network Interface unit so that upstream communications received by the hub from the at least two remote modems are passed through the RF Modem, converted by the protocol converter from the internal protocol to the external protocol, and then passed to the Network Interface unit before travel to one of the at least one central modem for transmission onto the external network; and
b) connects the Network Interface unit and the RF Modem so that downstream communications targeted for the particular remote modem are received by the Network Interface unit and converted from the external protocol to the internal protocol to be sent to a targeted remote modem out of the at least two remote modems.

14. The communications hub of claim 13 wherein the hub receives data communications from the at least one central modem is a 10baseT protocol and the protocol received from the at least two remote modems is a Point-to-Point protocol.

15. The communications hub of claim 13 wherein the means to provide signal strength feedback to the particular remote modem includes:
a) setting a target level for signal strength for upstream data communications received by the hub from the at least one remote modems;
b) comparing the measured signal strength with the target signal strength for an upstream data communication from a particular remote modem; and
c) sending a downstream data transmission directed to the particular remote modem accompanied by data from the hub indicating whether the signal strength of the previous upstream data transmission to the hub modem was above the target level.

16. The communications hub of claim 13 wherein the means to provide signal strength feedback to the particular remote modem includes:
a) setting a target level for signal strength for upstream data communications received by the hub from the at least one remote modems;
b) comparing the measured signal strength with the a target signal strength for an upstream data communication from a particular remote modem; and
c) sending a downstream data transmission directed to the particular remote modem accompanied by data from the hub indicating whether the signal strength of the previous upstream data transmission to the hub modem was below the target level.

17. The communications hub of claim 13 wherein the means to provide signal strength feedback to the particular remote modem includes:
a) setting a target level for signal strength for upstream data communications received by the hub from the at least one remote modems;
b) comparing the measured signal strength with the a target signal strength for an upstream data communication from a particular remote modem; and
c) sending a downstream data transmission directed to the particular remote modem with accompanied by a request from the hub to alter the transmission strength of upstream data transmission from the particular remote modem by a fixed amount based on the result of the most recent comparison of the measured signal strength with the target signal strength for the upstream data communication from the particular remote modem.

18. An internal communication network incorporating a cable television tree and branch network, the internal communications network comprising:
a) A first joiner device with an upstream connection to an external network, a first downstream connection and a second downstream connection;
b) A second joiner device with a first upstream connection, a second upstream connection and a downstream connection;
c) A TV path connecting the first downstream connection of the first joiner device to the first upstream connection of the second joiner device;
d) The TV channel amplifier connected as part of the TV path;
e) A bypass path around the TV channel amplifier, the bypass path starting at the second downstream connection of the first joiner device and ending at the second upstream connection of the second joiner device;
f) The bypass path including a communication hub and a cable modem upstream of the communication hub;
g) The communication hub including: a RF modem, a protocol converter, and a Network Interface unit;
h) The RF modem in communication with the data path to send and receive data transmissions through the second joiner device, the data transmissions in an internal communication protocol;
i) The Network Interface unit in communication with the cable modem using an external communication protocol;
j) The downstream connection of the second joiner device in communication with a tree and branch distribution system connected to at least two remote modems;
k) The communication hub serving as a proxy server to link the at least two remote modems to the cable modem;
l) The communication hub sending a downstream data communication to a particular remote modem comprising data for the particular remote modem received from the central modem after protocol conversion to internal communication protocol and signal strength feedback to indicate to the particular remote modem whether the last upstream communication from that particular remote modem received by the RF modem was below the target level for signal strength.
